(19) United States
(12) Patent Application Publication
(10) Pub. No.: US 2016/0034813 A1
(43) Pub. Date: Feb. 4, 2016

(54) METHOD FOR COUNTING NUMBER OF PEOPLE BASED ON APPLIANCE USAGES AND MONITORING SYSTEM USING THE SAME

(71) Applicant: National Chiao Tung University, Hsinchu City (TW)

(72) Inventors: Hsiao-Chiang Hsu, Hsinchu City (TW); Yung-Chi Chen, Hsinchu City (TW); Shiao-Li Tsao, Hsinchu City (TW)

(21) Appl. No.: 14/535,329

(22) Filed: Nov. 7, 2014

(30) Foreign Application Priority Data
Jul. 29, 2014 (TW) 103125838

(51) Int. Cl. G06N 3/08; G06N 3/04

(52) U.S. Cl. CPC G06N 3/08; G06N 3/04

(57) ABSTRACT

A method for counting a number of people based on appliance usages and a monitoring system using the same method. The method includes the following steps: collecting first numbers of people and first appliance usages corresponding to a first time duration in a specific space; establishing a predictive model related to the first time duration according to the first numbers of people and the appliance usages; detecting a second appliance usages in a second time duration; predicting a second number of people corresponding to the second time duration and the second appliance usages according to the predictive model.

### CROSS-REFERENCE TO RELATED APPLICATION

This application claims the priority benefit of Taiwan application serial no. 103125838, filed on Jul. 29, 2014. The entirety of the above-mentioned patent application is hereby incorporated by reference herein and made a part of this specification.

### BACKGROUND OF THE INVENTION

1. Field of the Invention

The invention relates to a method for counting the number of people and a monitoring system using the same, and particularly relates to a method for counting the number of people based on appliance usages and a monitoring system using the same.

2. Description of Related Art

In the modern society, due to the continuously increasing cost for power, the power-saving issue is gaining its importance in household and corporate sectors. The conventional power-saving systems usually provide the historical information of power consumption to households and corporations as the basis for comparing and saving power. However, the power usage in a space may differ with differences in dynamic factors such as space, number of users, and weather, etc., so the mere historical information of power consumption is not necessarily of value for reference. In addition, such information may not be easy for the user to interpret, so the information may not be helpful to the user in determining energy-saving strategies. Thus, whether an energy management system provides information about a space of the same type or a power usage benchmark as the reference for power saving is a key factor in this regard.

However, the power usage in a space may also differ as environmental factors such as the space size, the purpose of the space, the number of users in the space, and the weather, etc. In these environmental factors, static environmental factors such as the size and type of space and weather may be obtained through setting or other means. But it is rather challenging to obtain dynamic information such as the number of users in the space.

In the conventional method, several sensors must be set or the image processing technique must be used to determine the number of people. Among the conventional studies about counting the number of people, the systems for counting the number of people are mainly categorized into four types, which are image identification systems, infrared sensing systems, carbon dioxide concentration sensing systems, and other human machine interface systems such like Kinect.

Regarding the image identification systems, while such systems are easy to implement (e.g., only one video camera is required at one entrance), the cost for implementing such systems is higher since it requires high resolution video cameras, and the central processing unit thereof must handle a huge load of image processing. Regarding the infrared sensing systems, such systems detect the entrance of people based on variation in shielding and interruption of infrared rays. Therefore, the cost for implementing such systems is lower. However, since the sensors in an infrared sensing system must be disposed at both sides of the entrance, the flexibility of implementing such system is lower. The cost for implementing the carbon dioxide concentration sensing systems is also lower, since it only requires disposing a plurality of carbon dioxide concentration sensors to collect and determine the concentration of carbon dioxide in the space. However, since such system must also take air circulation caused by extraction fans and air conditioners into consideration, it is more difficult to be implemented in the real practice. As for the systems using Kinect, since the Kinect system of Microsoft or other human machine interface must be used as the main detecting equipment to determine actions of people, the cost for implementing such systems becomes higher.

### SUMMARY OF THE INVENTION

In view of the foregoing, the invention provides a method for counting the number of people based on appliance usages is capable of collecting appliance usages of appliances in operation by using a non-intrusive load monitoring meter, which has a lower cost for implementation, to estimate the number of people in a space. In this way, the method provided in the invention is allowed to factor in the estimation about the number of people in the space to more precisely analyze the power usage and provide a more accurate analysis report, so as to assist the user in improving habits of power consumption and provide the user with an effective power saving strategy.

The invention provides a method for counting the number of people based on appliance usages adapted for a monitoring system. The method includes steps as follows: collecting a plurality of first numbers of people and a plurality of first appliance usages corresponding to a first time duration in a specific space; establishing a predictive model related to the first time duration based on the plurality of first numbers of people and the plurality of first appliance usages; detecting a second appliance usage in a second time duration; and predicting a second number of people corresponding to the second time duration and the second appliance usage based on the predictive model.

According to an embodiment of the invention, the step of establishing the predictive model related to the first time duration based on the plurality of first numbers of people and the plurality of first appliance usages includes: executing an artificial neural network algorithm based on the plurality of first numbers of people and the plurality of first appliance usages to generate a plurality of weights and a plurality of offsets corresponding to a plurality of neurons in an artificial neural network; and establishing the predictive model based on the plurality of weights and the plurality of offsets.

According to an embodiment of the invention, the step of predicting the second number of people corresponding to the second time duration and the second appliance usage based on the predictive model includes: inputting the second appliance usage to the predictive model to calculate the second number of people based on the weights and the offsets.

According to an embodiment of the invention, the step of establishing the predictive model related to the first time duration based on the plurality of first numbers of people and the plurality of first appliance usages includes: inputting the plurality of first numbers of people and the plurality of first appliance usages to a support vector machine to find a classifier that classifies the plurality of first numbers of people and the plurality of first appliance usages; and establishing the predictive model based on the classifier.

According to an embodiment of the invention, the step of predicting the second number of people corresponding to the second time duration and the second appliance usage based on the predictive model includes: inputting the second appliance usage to the predictive model to find the second number of people corresponding to the second appliance usage based on the classifier.

According to an embodiment of the invention, the method further includes generating a power analysis report and providing a power usage suggestion based on the plurality of first numbers of people, the plurality of first appliance usages, the second appliance usage, and the second number of people.

The invention provides a monitoring system, including a detecting device and a computer device. The detecting device collects a plurality of first numbers of people and a plurality of first appliance usages corresponding to a first time duration in a specific space. The computer device is coupled to the detecting device. The computer device includes a storage unit and a processing unit. The storage unit stores a plurality of modules. The processing unit is coupled to the storage unit to access and execute the plurality of modules recorded in the storage unit. The plurality of modules include a model establishing module, a detecting module, and a predicting module. The model establishing module establishes a predictive model related to the first time duration based on the plurality of first numbers of people and the plurality of first appliance usages. The detecting module controls the detecting device to detect a second appliance usage in a second time duration. The predicting module predicts a second number of people corresponding to the second time duration and the second appliance usage based on the predictive model.

According to an embodiment of the invention, the model establishing module is configured to execute an artificial neural network algorithm based on the plurality of first numbers of people and the plurality of first appliance usages to generate a plurality of weights and a plurality of offsets corresponding to a plurality of neurons in an artificial neural network, and establish the predictive model based on the plurality of weights and the plurality of offsets.

According to an embodiment of the invention, the predictive model inputs the second appliance usage to the predictive model to calculate the second number of people based on the weights and the offsets.

According to an embodiment of the invention, the model establishing module is configured to input the plurality of first numbers of people and the plurality of first appliance usages to a support vector machine to find a classifier that classifies the plurality of first numbers of people and the plurality of first appliance usages, and establish the predictive model based on the classifier.

According to an embodiment of the invention, the predictive module inputs the second appliance usage to the predictive model to find the second number of people corresponding to the second appliance usage based on the classifier.

According to an embodiment of the invention, the predictive module further generates a power analysis report and provides a power usage suggestion based on the plurality of first numbers of people, the plurality of first appliance usages, the second appliance usage, and the second number of people.

The invention provides a method for counting the number of people based on appliance usages adapted for a monitoring system. The method includes steps as follows: converting a plurality of first appliance types corresponding to a first time duration in a plurality of first spaces and respective first appliance numbers of the plurality of first appliance types into a plurality of training vectors, wherein the plurality of first spaces correspond to a specific space; converting a plurality of second appliance types corresponding to the first time duration in the specific space and respective second appliance numbers of the plurality of second appliance types into a testing vector; generating a maximal testing vector based on the plurality of training vectors and the testing vector, wherein the maximal testing vector includes a plurality of elements, and the elements respectively correspond to the plurality of first appliance types; finding a plurality of specific elements that are not 0 from the plurality of elements; retrieving a plurality of first appliance usages corresponding to each of the specific elements, wherein the first appliance usages correspond to a plurality of first numbers of people; executing a principal component analysis on the plurality of first appliance usages corresponding to each of the specific elements to respectively find a principal component of each of the plurality of first appliance usages; inputting the principal component of each of the plurality of first appliance usages to a support vector machine to find a classifier that classifies the principal component of each of the first appliance usages; detecting a second appliance usage in a second time duration; and finding a second number of people corresponding to the second appliance usage based on the classifier.

According to an embodiment of the invention, the method further includes generating a power analysis report and providing a power usage suggestion based on the plurality of first numbers of people, the plurality of first appliance usages, the second appliance usage, and the second number of people.

The invention provides a monitoring system, including a detecting device and a computer device. The computer device is coupled to the detecting device. The computer device includes a storage unit and a processing unit. The storage unit stores a plurality of modules. The processing unit is coupled to the storage unit to access and execute the plurality of modules recorded in the storage unit. The plurality of modules include a first converting module, a second converting module, a generating module, a searching module, an appliance usage retrieving module, an analysis module, a classifying module, a detecting module, and a predicting module. The first converting module converts a plurality of first appliance types corresponding to a first time duration in a plurality of first spaces and respective first appliance numbers of the plurality of first appliance types into a plurality of training vectors. The second converting module converts a plurality of second appliance types corresponding to the first time duration in the specific space and respective second appliance numbers of the plurality of second appliance types into a testing vector. The generating module generates a maximal testing vector based on the plurality of training vectors and the testing vector, wherein the maximal testing vector includes a plurality of elements, and the elements respectively correspond to the plurality of first appliance types. The searching module finds a plurality of specific elements that are not 0 from the plurality of elements. The appliance usage retrieving module retrieves a plurality of first appliance usages corresponding to each of the plurality of specific elements. The analysis module executes a principal component analysis on the plurality of first appliance usages corresponding to each of the specific elements to respectively find a principal component of each of the plurality of first appliance usages, wherein the plurality of first appliance usages correspond to the plurality of first numbers of people. The classifying module inputs the principal component of each of the plurality of first appliance usages to a support vector machine to find a classifier that classifies the principal component of each of the first appliance usages. The detecting module controls the detecting device to detect a second appliance usage in a second time duration, wherein the second time duration corresponds to the first time duration. The predicting module predicts a second number of people corresponding to the second appliance usage based on the classifier.

According to an embodiment of the invention, the predictive module further generates a power analysis report and provides a power usage suggestion based on the plurality of first numbers of people, the plurality of first appliance usages, the second appliance usage, and the second number of people.

Based on the above, in the method provided in the embodiments of the invention, the predictive models suitable for the specific space are arrived at based on the mechanisms of supervised training and semi-supervised training. In addition, the method is capable of correctly predicting the number of people corresponding to the appliance usage in the specific space based on the predictive model when detecting other appliance usages.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a monitoring system according to an embodiment of the invention.

FIG. 2 is a flowchart illustrating a method for counting the number of people based on appliance usages according to an embodiment of the invention.

FIG. 3A is a schematic view illustrating an artificial neural network according to a first embodiment of the invention.

FIG. 3B is a view illustrating a neuron architecture according to the first embodiment of the invention.

FIG. 4 is a schematic view illustrating a monitoring system according to an embodiment of the invention.

FIG. 5 is a flowchart illustrating a method for counting the number of people based on appliance usages according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

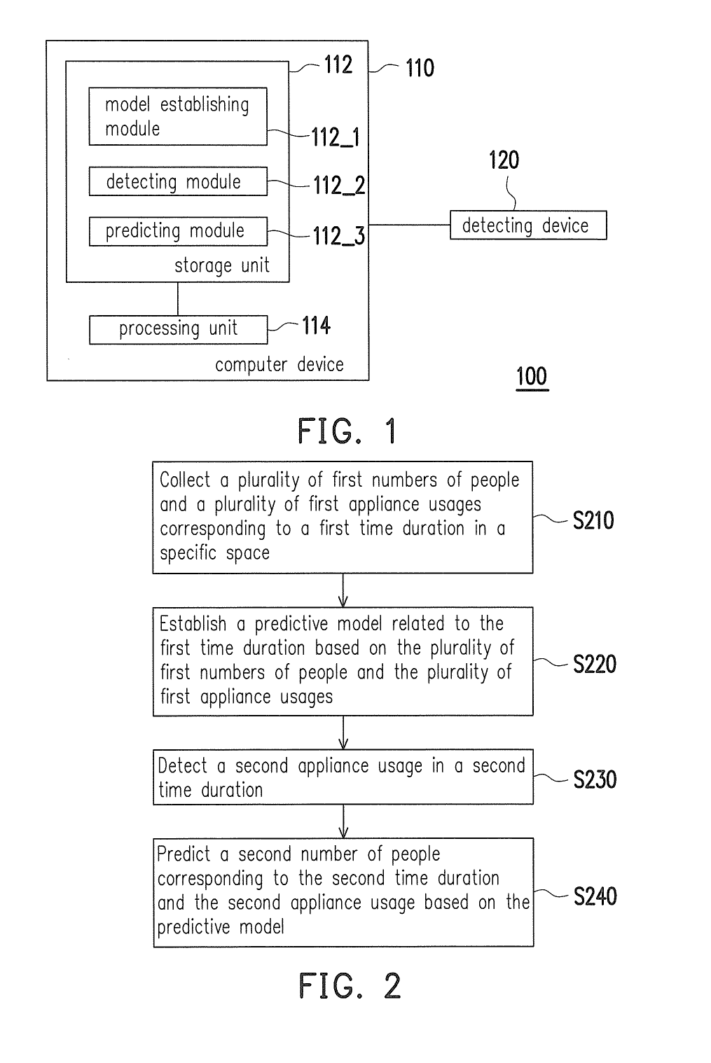

FIG. 1 is a schematic view illustrating a monitoring system according to an embodiment of the invention. In this embodiment, a monitoring system 100 includes a computer device 110 and a detecting device 120. The detecting device 120 is a non-intrusive load monitoring meter, for example, adapted to detect a power signature of a space where the meter is located (e.g., in a household residence, office, and room, etc.). The power signature includes features such as voltage, current, real power, reactive power, etc., in a loop of the space. Based on the power signature, the detecting device 120 may determine statuses and power consumption of appliances in the loop in the space.

The computer device 110 is coupled to the detecting device 120. The computer device 110 is a smart phone, a tablet computer, personal digital assistant (PDA), a personal computer (PC), a notebook computer, a work station, or other similar devices. The computer device 110 includes a storage unit 112 and a processing unit 114. The storage unit 112 is a memory, a hard disk, or other elements capable of storing data, for example, and is capable of recording a plurality of modules.

The processing unit 114 is coupled to the storage unit 112. The processing unit 114 may be a general purpose processor, a specific purpose processor, a conventional processor, a digital signal processor, multiple microprocessors, one or more microprocessors integrated with a digital signal processor core, a controller, a microcontroller, an application specific integrated circuit (ASIC), a field programmable gate array (FPGA), and any other integrated circuits, state machines, processors, or the like.

In this embodiment, the processing unit 114 may access a model establishing module 112_1, a detecting module 112_2 and a predicting module 112_3 stored in the storage unit 112 to execute each step in a method for counting the number of people based on appliance usages in the invention.

FIG. 2 is a flowchart illustrating a method for counting the number of people based on appliance usages according to an embodiment of the invention. The method of this embodiment may be executed by the monitoring system 100 shown in FIG. 1. In the following, details with respect to the method are described with reference to the components shown in FIG. 1.

At Step S210, the detecting device 120 collects a plurality of first numbers of people and a plurality of first appliance usages corresponding to a first time duration in a specific space. The specific space may be one or more spaces such as household residences, rooms, kitchens, and offices, etc. However, the embodiments of the invention are not limited thereto. The first time duration may be a time duration arbitrarily set by the designer, such as from 9:00 AM to 10:00 AM and 3:00 PM to 5:00 PM, for example.

The first numbers of people are, for example, the numbers of people appearing in the specific space during the first time duration on different dates. For example, given that the first time duration is from 9:00 AM to 10:00 AM, the detecting device 120 may collect the daily numbers of people appearing in the specific space during 9:00 AM to 10:00 AM for a certain period of time (e.g., a month). Then, the detecting device 120 (or computer device 110) may define the numbers of people recorded during this period of time as the first numbers of people. In other words, one of the first numbers of people is the number of people appearing in the specific space during the first time duration in that day.

The first appliance usages are, for example, usages (e.g., power consumption, etc.) of appliances in the specific space in the first time duration on different dates. For example, given that the first time duration is from 9:00 AM to 10:00 AM, the detecting device 120 may collect the daily power consumptions of each of the appliances in the specific space during 9:00 AM to 10:00 AM for a certain period of time (e.g., a month). Then, the detecting device 120 (or the computer device 110) may define the power consumptions recorded during this period of time as the first appliance usages. In other words, one of the first appliance usages is the usage of the appliances in the specific space during the first time duration in a day.

Then, at Step S220, the processing unit 114 executes the model establishing module 112_1 to establish a predictive model related to the first time duration based on the plurality of first numbers of people and the plurality of first appliance usages. In a first embodiment, the model establishing module 112_1 may execute an artificial neural network (ANN) algorithm based on the plurality of first numbers of people and the plurality of appliance usages to produce a plurality of weights and offsets corresponding to a plurality of neurons in the artificial neural network. In a second embodiment, the model establishing module 112_1 may establish the predictive model based on a mechanism of support vector machine (SVM). Details of the first and second embodiments will be described in detail in the following.

After establishing the predictive model, at Step S230, the processing unit 114 executes the detecting module 112_2 to control the detecting device 120 to detect a second appliance usage in a second time duration.

The second time duration corresponds to the first time duration. In an embodiment, the second time duration and the first time duration may be the same time duration, but the time durations may respectively correspond to different dates. For example, given that the first time duration is from 9:00 AM to 10:00 AM on a first date, the second time duration may be from 9:00 AM to 10:00 AM on a second date different from the first date. However, the embodiments of the invention are not limited thereto.

Then, at Step S240, the processing unit 114 executes the predicting module 112_3 to predict a second number of people corresponding to the second time duration and the second appliance usage based on the predictive model. In other words, after the model establishing module 112_1 establishes the predictive model, the predicting module 112_3 correspondingly predicts the number of people (i.e., the second number of people) appearing in the specific space during the second time duration, as long as the detecting device 120 detects the second appliance usage in the second time duration.

As noted in the previous embodiment, the model establishing module 112_1 may establish the predictive model based on the first embodiment and the second embodiment. Since the predictive models established in the first and second embodiments are different, mechanisms for the predictive module 112_3 to predict the second number of people are also different. Details about the first and second embodiments are respectively described below.

Roughly speaking, in the first embodiment, the model establishing module 112_1 trains neurons in an artificial neural network based on the plurality of first numbers of people and the plurality of first appliance usages. Then, the predictive model 112_3 predicts the second number of people corresponding to the second appliance usage based on the trained artificial neural network.

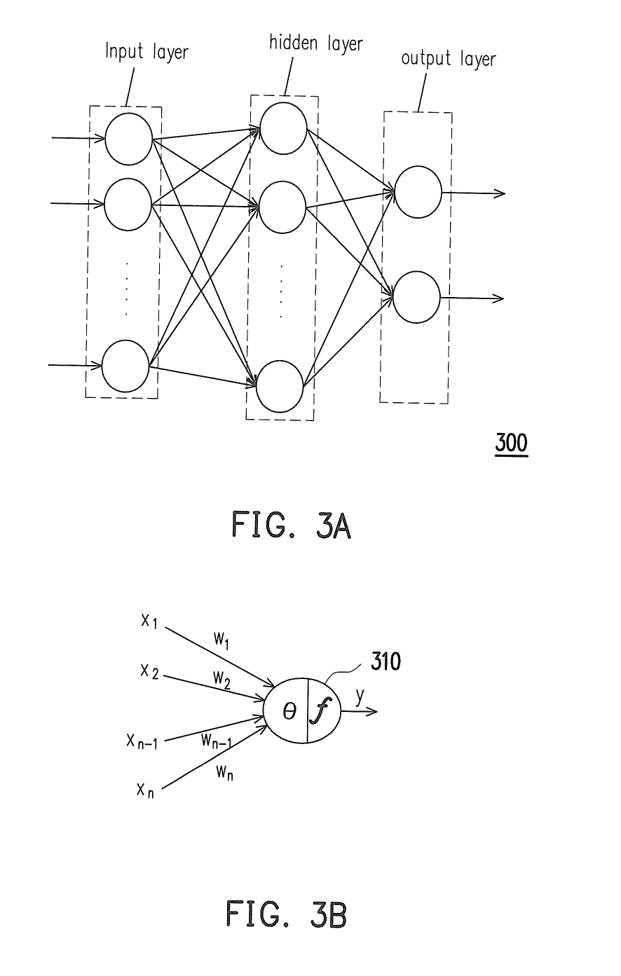

Referring to FIG. 3A, FIG. 3A is a schematic view illustrating the artificial neural network according to the first embodiment of the invention. In this embodiment, an artificial neural network 300 includes an input layer, a hidden layer, and an output layer. Components in layers (represented by circles) are neurons in the artificial neural network 300.

Referring to FIG. 3B, FIG. 3B is a view illustrating a neuron architecture according to the first embodiment of the invention. In this embodiment, when a neuron 310 receives n (n is a positive integer) input values (represented by x₁ to xₙ), the model establishing module 112_1 may compute a first function based on x₁ to xₙ, n weights (represented by w₁ to wₙ), and offsets (represented by θ), so as to generate an output value (represented by y). The first function is, for example,

$$y = f ( {\sum }_{i = 1}^{n} {x}_{i} {w}_{i} + θ ) , wherein f ( k ) = \frac{1}{1 + {e}^{- k}} .$$

In this embodiment, the model establishing module 112_1 may train neurons in the artificial neural network 300 based on the plurality of first numbers of people and the plurality of first appliance usages, so as to adaptively calculate the weight (e.g., w₁ to wₙ) and the offset (e.g., θ) of each neuron according to the plurality of first numbers of people and the plurality of first appliance usages. From another perspective, the model establishing module 112_1 may treat the plurality of first appliance usages and the plurality of numbers of people as input and output values of the neurons, so as to adjust the weights and the offsets of the neurons.

After finishing training the neurons in the artificial neural network 300, the model establishing module 112_1 establishes the predictive model (i.e., the trained artificial neural network 300) based on the weight and the offset of each neuron.

Then, when the predicting device 120 detects the second appliance usage in the second time duration, the predicting module 112_3 inputs the second appliance usage to the predictive model (i.e., the trained artificial neural network 300) to calculate the second number of people based on the weight and the offset of each neuron.

In the second embodiment, the model predictive module 112_1 trains a support vector machine based on the plurality of first numbers of people and the first appliance usages, thereby finding a classifier in the support vector machine. Then, the predictive module 112_3 predicts the second number of people corresponding to the second appliance usage based on the classifier.

Specifically, the plurality of first appliance usages may be considered to be distributed in a data space. Since each first appliance usage corresponds to one of the first numbers of people, the first appliance usages corresponding to the same first number of people should be very close in the data base. If the first appliance usages corresponding to the same first number of people are treated as a group, the data space may be considered as having a plurality of groups respectively corresponding to different first numbers of people. Thus, the model establishing module 112_1 may find a hyperplane, i.e., the classifier that classifies the groups in the data space based on the mechanism of support vector machine. The hyperplane (i.e., classifier) may be exemplarily represented as a second function in the form of aᵢ=g(bᵢ), where bᵢ is one of the appliance usages, and aᵢ is the first number of people corresponding to the appliance usage.

The model establishing module 112_1 may continuously train the classifier based on the corresponding relation between the plurality of first numbers of people and the plurality of first appliance usages, for example, to adjust the second function. After training for the second function is completed, the model establishing module 112_1 defines the second function as the predictive model, so that the predicting module 112_3 may subsequently make prediction about the second number of people based on the predictive model.

It should be noted that the first and second embodiments above may be generally referred to as supervised training. In other words, given that the monitoring system 100 already knows the corresponding relation between the first numbers of people and the first appliance usages of the specific space in the past, the computer device 110 may train a predictive model (e.g., an artificial neural network, a support vector machine or other classifiers) suitable for the specific space based on the corresponding relation. In this way, when the detecting device 120 subsequently detects the second appliance usage, the computer device 110 is consequently able to precisely predict the second number of people corresponding to the second appliance usage based on the trained predictive model.

After being informed with the second number of people and the second appliance usage at a certain time point (e.g., the second time duration), the monitoring system 100 thus uses the information to provide the user with a power saving suggestion. For example, when an unreasonable power usage is found in the specific space (e.g., a high power consumption is found when no one appears in the specific space), the monitoring system 100 may notify the user. Accordingly, the user may save the power usage by correspondingly turning off unnecessary appliances, for example.

In addition, the monitoring system 100 may also generate a power analysis report based on the number of people and appliance usages in the specific space to provide historical information of power consumption to the user. Furthermore, the monitoring system 100 may also provide a power analysis suggestion to the user to allow the user to check whether the appliances are used appropriately.

Although the predictive model based on the supervised learning mechanism helps the computer device 110 precisely predict the second number of people corresponding to the second appliance usage, it still requires the first numbers of people and the first appliance usages of the specific space in the past to train the precise predictive model. Thus, when such information is not available, the predictive model is unable to be established successfully.

Thus, a method for establishing a predictive model based on semi-supervised training is further provided in the embodiments of the invention. Such method is adapted to establish a suitable predictive model based on other similar spaces to correctly predict the number of people when the information of the specific space is not available.

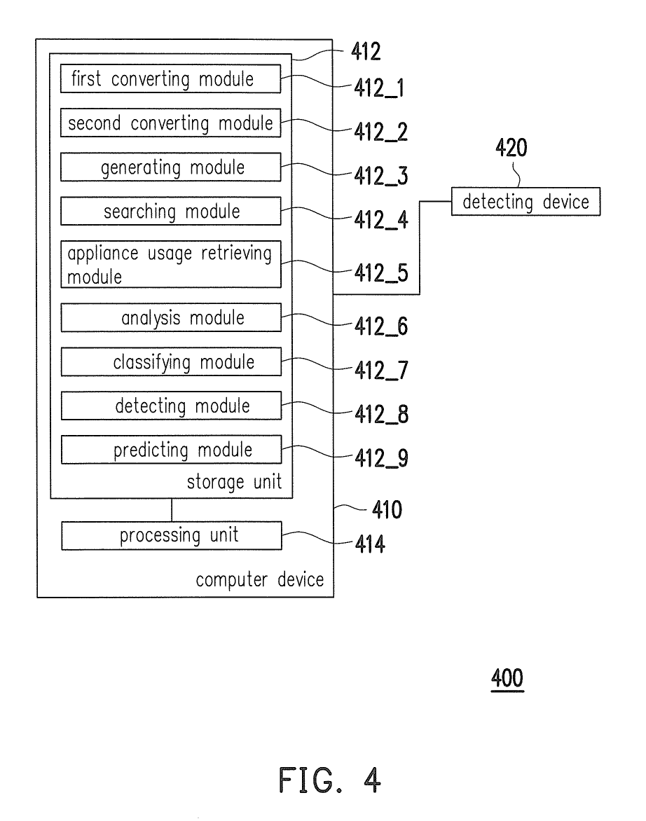

FIG. 4 is a schematic view illustrating a monitoring system according to an embodiment of the invention. Referring to FIG. 4, a monitoring system 400 includes a computer device 410 and a predicting device 420. The computer device 410 includes a storage unit 412 and a processing unit 414. Embodiments of the computer device 410, the detecting device 420, the storage unit 412, and the processing unit 414 may be referred to the description about the computer device 110, the detecting device 120, the storage unit 112, and the processing unit 114, and no further details in this respect will reiterated below.

In this embodiment, the processing unit 414 may access a first converting module 412_1, a second converting module 412_2, a generating module 412_3, a searching module 412_4, an appliance usage retrieving module 412_5, an analysis module 412_6, a classifying module 412_7, a detecting module 412_8, and a predicting module 412_9 to execute each step of a method for counting the number of people based on appliance usages according to the embodiment of the invention.

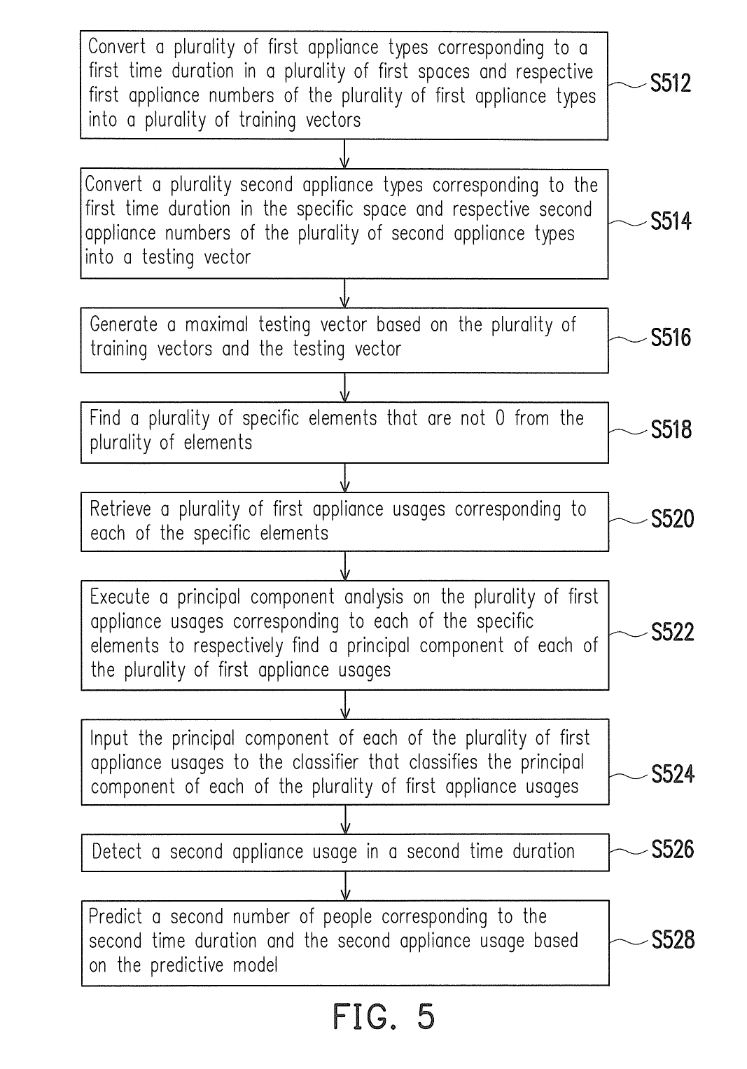

FIG. 5 is a flowchart illustrating a method for counting the number of people based on appliance usages according to an embodiment of the invention. The method of this embodiment may be executed by the monitoring system 400 shown in FIG. 4. In the following, details with respect to the method are described with reference to the components shown in FIG. 4.

At Step S512, the processing unit 414 executes the first converting module 412_1 to convert a plurality of first appliance types corresponding to the first time duration in a plurality of first spaces and respective first appliance numbers of the plurality of first appliance types into a plurality of training vectors. The first spaces correspond to the specific space, for example. For example, given that the specific space is kitchen, the plurality of first spaces may respectively be kitchens of difference household residences. However, the invention is not limited thereto. The first appliance types may be TV, refrigerator, air conditioner, computer, and other appliances, for example. The first appliance number is the number of the first appliance type (e.g., the number of TVs).

Each training vector corresponds to one of the plurality of first spaces. For example, the iₜₕ (i is a positive integer) training vector corresponds to the iₜₕ first space, for example. For the iₜₕ training vector, each training vector element included therein is, for example, the first appliance number of one of the first appliance types, for example. Here, it is set that the first to third training vector elements respectively correspond to TV, refrigerator, and air conditioner. Under this circumstance, given that the iₜₕ first space includes two TVs, one refrigerator, and three air conditioners, the iₜₕ training vector may be represented as a vector of [2 1 3]. For another example, given that the jₜₕ (j is a positive integer) first space includes one TV, two refrigerators, and three air conditioners, the jₜₕ training vector may be represented as a vector of [1 2 3]. However, the embodiments of the invention are not limited thereto.

Then, at Step S514, the processing unit 414 executes the second converting module 412_2 to convert a plurality second appliance types corresponding to the first time duration in the specific space and respective second appliance numbers of the plurality of second appliance types into a testing vector. Similar to the first appliance types, the second appliance types may also be TV, refrigerator, air conditioner, computer, and other appliances. The second appliance number is the number of the second appliance type (e.g., the number of TVs).

For the testing vector, each testing element included therein is the second appliance number of one of the second appliance types, for example. Here, it is set that the first to third testing elements of the testing vector respectively correspond to TV, refrigerator, and air conditioner. Under this circumstance, given that the specific space includes three TVs, two refrigerators and one air conditioner, the testing vector may be represented as a vector of [1 2 3].

At Step S516, the processing unit 414 executes the generating module 412_3 to generate a maximal testing vector based on the plurality of training vectors and the testing vector. The maximal testing vector may include a plurality of elements, and the elements correspond to the plurality of first appliance types.

In an embodiment, the generating module 412_3 finds a maximal value of a training element corresponding to each index value in the plurality of training vectors, and sets the element corresponding to each index value in the maximal testing vector accordingly. For example, it is set that the first training vector and the second training vector are respectively [1 3 1 2] and [0 1 2 4]. Under this circumstance, the maximal value of the training element corresponding to the first index value is 1, the maximal value of the training element corresponding to the second index value is 3, the maximal value of the training element corresponding to the third index value is 2, and the maximal value of the training element corresponding to the fourth index value is 4. Then, the generating module 412_3 sets the elements corresponding to the first to fourth index values in the maximal testing vector as 1, 3, 2, and 4. In other words, the maximal testing vector may be represented as a vector of [1 3 2 4].

Then, the generating module 412_3 finds a testing element equal to 0 in the testing vector and set the element having the corresponding index value in the maximal testing vector as 0. For example, given that the third testing element in the testing vector is 0, the generating module 412_3 may correspondingly set the third element of the maximal testing vector as 0. Thus, the maximal testing vector, originally represented as [1 3 2 4], is correspondingly modified as [1 3 0 4].

At Step S518, the processing unit 414 executes the searching module 412_4 to find a plurality of specific elements that are not 0 from the plurality of elements. Taking the maximal testing vector represented as [1 3 0 4] as an example, the specific elements that are not 0 are 1, 3, and 4.

Then, at Step S520, the processing unit 114 executes the appliance usage retrieving module 412_5 to retrieve the plurality of first appliance usages corresponding to each of the specific elements. Specifically, since each of the specific elements is the first number of appliance of a first appliance type, the appliance usage retrieving module 412_5 may retrieve the first appliance usages corresponding to the first appliance type. In other words, assuming that a specific element is 3, it thus represents that the specific element corresponds to three appliances that belong to the same appliance type (e.g., three TVs). Under this assumption, the appliance usage retrieving module 412_5 retrieves the respective first appliance usages of the three TVs. Taking another example, assuming that a specific element is 2, it thus represents that this specific element corresponds to two appliances that belong to the same appliance type (e.g., two air conditioners). Under this assumption, the appliance usage retrieving module 412_5 retrieves the respective first appliance usages of the two air conditioners.

Then, at Step S522, the processing unit 414 executes the analysis module 412_6 to execute a principal component analysis (PCA) on the plurality of first appliance usages corresponding to each of the specific elements to respectively find a principal component of each of the plurality of first appliance usages.

At Step S524, the processing unit 414 executes the classifying module 412_7 to input the respective principal components of the plurality of first appliance usages to the support vector machine, so as to find the classifier that classifies the principal component of each of the plurality of first appliance usages. Details about Step S524 may be referred to the description about the second embodiment, and no further details in this respect will be repeated below.

At Step S526, the processing unit 414 executes the detecting module 412_8 to control the detecting device 420 to detect the second appliance usage in the second time duration. Also, at Step S528, the processing unit 414 executes the predicting module 412_9 to find the second number of people corresponding to the second appliance usage based on the classifier. Details about S526 and S528 may be referred to the description about the second embodiment, and no further details in this respect will be repeated below.

Thus, when the information about the first number of people and the first appliance usages of the specific space in the past is not available, the method provided in the embodiments of the invention is still able to establish the classifier (i.e., the predictive model) of the specific space by using the information of other first spaces (corresponding to the specific space). Moreover, when the detecting device 420 subsequently detects the second appliance usage, the computer device 410 is able to correctly predict the second number of people corresponding to the second appliance usage based on the classifier.

In brief, the method provided in this embodiment is capable of using information collected in other first spaces in the corresponding specific space to find the suitable classifier. For example, given that the specific space is kitchen, the method of the embodiment may, for example, use information (e.g., the first appliance usages and the corresponding first numbers of people) collected in kitchens of other buildings to establish the classifier related to the specific space. In this way, the computer device 410 is still capable of predicting the corresponding second number of people when detecting the second appliance usage based on the classifier.

In view of the foregoing, the method provided in the embodiments of the invention, the predictive models suitable for the specific space are arrived at based on the mechanisms of supervised training and semi-supervised training. In addition, the method is capable of correctly predicting the number of people corresponding to the appliance usage in the specific space based on the predictive model when detecting other appliance usages. In this way, when an unreasonable electricity usage is found in the specific space (e.g., a great power consumption is found when no one appears in the specific space), the monitoring system is able to notify the user, so that the user may save power by correspondingly turning off unnecessary appliances, for example. In addition, the monitoring system may also generate a power analysis report based on the number of people and appliance usages in the specific space to provide historical information of power consumption to the user. Furthermore, the monitoring system may also provide a power analysis suggestion to the user to allow the user to check whether the appliances are used appropriately.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for counting the number of people based on appliance usages, adapted for a monitoring system, comprising:
collecting a plurality of first numbers of people and a plurality of first appliance usages corresponding to a first time duration in a specific space;
establishing a predictive model related to the first time duration based on the plurality of first numbers of people and the plurality of first appliance usages;
detecting a second appliance usage in a second time duration; and
predicting a second number of people corresponding to the second time duration and the second appliance usage based on the predictive model.

2. The method as claimed in claim 1, wherein the step of establishing the predictive model related to the first time duration based on the plurality of first numbers of people and the plurality of first appliance usages comprises:
executing an artificial neural network algorithm based on the plurality of first numbers of people and the plurality of first appliance usages to generate a plurality of weights and a plurality of offsets corresponding to a plurality of neurons in an artificial neural network; and
establishing the predictive model based on the weights and the offsets.

3. The method as claimed in claim 2, wherein the step of predicting the second number of people corresponding to the second time duration and the second appliance usage based on the predictive model comprises:
inputting the second appliance usage to the predictive model to calculate the second number of people based on the weights and the offsets.

4. The method as claimed in claim 1, wherein the step of establishing the predictive model related to the first time duration based on the plurality of first numbers of people and the plurality of first appliance usages comprises:
inputting the plurality of first numbers of people and the plurality of first appliance usages to a support vector machine to find a classifier that classifies the plurality of first numbers of people and the plurality of first appliance usages; and
establishing the predictive model based on the classifier.

5. The method as claimed in claim 4, wherein the step of predicting the second number of people corresponding to the second time duration and the second appliance usage based on the predictive model comprises:
inputting the second appliance usage to the predictive model to find the second number of people corresponding to the second appliance usage based on the classifier.

6. The method as claimed in claim 1, further comprising:
generating a power analysis report and providing a power usage suggestion based on the plurality of first numbers of people, the plurality of first appliance usages, the second appliance usage, and the second number of people.

7. A monitoring system, comprising:
a detecting device, collecting a plurality of first numbers of people and a plurality of first appliance usages corresponding to a first time duration in a specific space; and
a computer device, coupled to the detecting device, the computer device comprising:
a storage unit, storing a plurality of modules; and
a processing unit, coupled to the storage unit, accessing and executing the plurality of modules recorded in the storage unit, wherein the plurality of modules comprise:
a model establishing module, establishing a predictive model related to the first time duration based on the plurality of first numbers of people and the plurality of first appliance usages;
a detecting module, controlling the detecting device to detect a second appliance usage in a second time duration; and
a predicting module, predicting a second number of people corresponding to the second time duration and the second appliance usage based on the predictive model.

8. The system as claimed in claim 7, wherein the model establishing module is configured to:
executing an artificial neural network algorithm based on the plurality of first numbers of people and the plurality of first appliance usages to generate a plurality of weights and a plurality of offsets corresponding to a plurality of neurons in an artificial neural network; and
establish the predictive model based on the weights and the offsets.

9. The system as claimed in claim 8, wherein the predictive module inputs the second appliance usage to the predictive model to calculate the second number of people based on the weights and the offsets.

10. The system as claimed in claim 7, wherein the model establishing module is configured to:
input the plurality of first numbers of people and the plurality of first appliance usages to a classifier that classifies the plurality of first numbers of people and the plurality of first appliance usages; and
establish the predictive model based on the classifier.

11. The system as claimed in claim 10, wherein the predictive module inputs the second appliance usage to the predictive model to find the second number of people corresponding to the second appliance usage based on the classifier.

12. The system as claimed in claim 7, wherein the predictive module further generates a power analysis report and provides a power usage suggestion based on the plurality of first numbers of people, the plurality of first appliance usages, the second appliance usage, and the second number of people.

13. A method for counting the number of people based on appliance usages, adapted for a monitoring system, comprising:
converting a plurality of first appliance types corresponding to a first time duration in a plurality of first spaces and respective first appliance numbers of the plurality of first appliance types into a plurality of training vectors, wherein the plurality of first spaces correspond to a specific space;
converting a plurality of second appliance types corresponding to the first time duration in the specific space and respective second appliance numbers of the plurality of second appliance types into a testing vector;
generating a maximal testing vector based on the plurality of training vectors and the testing vector, wherein the maximal testing vector comprises a plurality of elements, and the elements respectively correspond to the plurality of first appliance types;
finding a plurality of specific elements that are not 0 from the plurality of elements;
retrieving a plurality of first appliance usages corresponding to each of the specific elements, wherein the first appliance usages correspond to a plurality of first numbers of people;
executing a principal component analysis on the plurality of first appliance usages corresponding to each of the specific elements to respectively find a principal components of the plurality of first appliance usages;
inputting the principal component of each of the plurality of first appliance usages to a support vector machine to find a classifier that classifies the principal component of each of the first appliance usages;
detecting a second appliance usage in a second time duration; and
finding a second number of people corresponding to the second appliance usage based on the classifier.

14. The method as claimed in claim 13, further comprising:
generating a power analysis report and providing a power usage suggestion based on the plurality of first numbers of people, the plurality of first appliance usages, the second appliance usage, and the second number of people.

15. A monitoring system, comprising:
a detecting device; and
a computer device, coupled to the detecting device, the computer device comprising:
a storage unit, storing a plurality of modules; and
a processing unit, coupled to the storage unit, accessing and executing the plurality of modules recorded in the storage unit, wherein the plurality of modules comprise:
a first converting module, converting a plurality of first appliance types corresponding to a first time duration in a plurality of first spaces and respective first appliance numbers of the plurality of first appliance types into a plurality of training vectors, wherein the plurality of first spaces correspond to a specific space;
a second converting module, converting a plurality of second appliance types corresponding to the first time duration in the specific space and respective second appliance numbers of the plurality of second appliance types into a testing vector;
a generating module, generating a maximal testing vector based on the plurality of training vectors and the testing vector, wherein the maximal testing vector comprises a plurality of elements, and the elements respectively correspond to the plurality of first appliance types;
a searching module, finding a plurality of specific elements that are not 0 from the plurality of elements;
an appliance usage retrieving module, retrieving a plurality of first appliance usages corresponding to each of the plurality of specific elements;
an analysis module, executing a principal component analysis on the plurality of first appliance usages corresponding to each of the specific elements to respectively find a principal components of each of the plurality of first appliance usages, wherein the plurality of first appliance usages correspond to the plurality of first numbers of people;
a classifying module, inputting the principal component of each of the plurality of first appliance usages to a classifier that classifies the principal component of each of the first appliance usages;
a detecting module, controlling the detecting device to detect a second appliance usage in a second time duration; and
a predicting module, predicting a second number of people corresponding to the second appliance usage based on the classifier.

16. The system as claimed in claim 15, wherein the predictive module further generates a power analysis report and provides a power usage suggestion based on the plurality of first numbers of people, the plurality of first appliance usages, the second appliance usage, and the second number of people.
